(19) United States
(12) Patent Application Publication
(10) Pub. No.: US 2019/0066036 A1
(43) Pub. Date: Feb. 28, 2019

(54) METHOD AND APPARATUS FOR DISTRIBUTED ASSET LOCATION MONITORING

(71) Applicants: Roger Roisen, Minnetrista, MN (US); Michael McHugh, Plymouth, MN (US); Craig S. Wilson, Arden Hills, MN (US); Shane McCarron, Arden Hills, MN (US)

(72) Inventors: Roger Roisen, Minnetrista, MN (US); Michael McHugh, Plymouth, MN (US); Craig S. Wilson, Arden Hills, MN (US); Shane McCarron, Arden Hills, MN (US)

(21) Appl. No.: 16/119,364

(22) Filed: Aug. 31, 2018

Related U.S. Application Data
(60) Provisional application No. 62/552,851, filed on Aug. 31, 2017.

(51) Int. Cl. G06Q 10/08; G06K 19/07; H04W 4/80; H04W 4/029

(52) U.S. Cl. CPC G06Q 10/087; H04W 4/029; H04W 4/80; G06K 19/0723

(57) ABSTRACT

A method or system for distributed asset location monitoring may include determining a current device location of a mobile electronic device, sending the current device location to an asset-tracking device, receiving a previous asset location from the asset-tracking device, and storing the current device location and the previous asset location in an asset-tracking record. In some examples, the asset-tracking device includes a Bluetooth radio tag, and the loss or the acquisition of the Bluetooth signal generates the event signal to capture the time stamp and geographic location of the asset and map that data in the cloud. In some examples, the asset-tracking device includes an environmental data logger, and the Bluetooth tag may store environmental data including temperature, humidity, barometric elevation, or acceleration.

### BACKGROUND

Many service companies use containers to facilitate distribution or retrieval of materials. For example, a waste removal service may place a rubbish dumpster at each customer's location. The distributed nature of the containers creates several logistical challenges, including inventory management, service call routing, and loss prevention.

Location-based devices, such as Global Positioning System (GPS) device, may provide a location of the device. However, it is impractical to include a location-based device on every container due to the device power requirements, cost, and other considerations.

### SUMMARY

A method or system for distributed asset location monitoring may include executing software on circuitry of a mobile electronic device, the method or system including determining a current device location of a mobile electronic device, sending the current device location to an asset-tracking device, receiving a previous asset location from the asset-tracking device, and storing the current device location and the previous asset location in an asset-tracking record. In some examples the mobile electronic device may be a mobile hand held personal communication device or a permanently mounted single board computer with Wi-Fi, GPS, and cellular connectivity. In some examples, the asset-tracking device includes a Bluetooth Beacon and losing connectivity to the Bluetooth device on the asset acts as a sensor function indicating that the asset has been delivered to the current location and that the asset-tracking device has left the current location. In some examples, the asset-tracking device includes a Bluetooth Beacon and losing the ability to detect to the Bluetooth devices advertising packet on mobile device or single board computer inside the truck cab acts as a sensor function indicating that the truck has left the asset at the current location. This inability to detect the advertising packet acts as a sensor function indicating that the asset has been left at the current location. This sensing signal activates the mobile device to send the current time and location and any other sensor data collected to the cloud and map that data. In this example the same can be said for the acquisition of the Bluetooth signal or the ability to detect the Bluetooth advertising packet. This acquisition is the signal that the asset has been retrieved and the time and location and any other sensor data is sent to the cloud and mapped. In some examples, the asset-tracking device includes an environmental data sensor, and the Bluetooth tag may store environmental data including temperature, humidity, barometric elevation, acceleration, or other sensor data from the Bluetooth tag environment. These data points may indicate an event such as retrieval of refuse from a roll off dumpster. For example, an accelerometer or gyroscope may be used to determine that a roll off dumpster has been moved or tipped, indicating that refuse has been retrieved.

### BRIEF DESCRIPTION OF THE DRAWINGS

FIG. 1 illustrates a system implementation according to an example embodiment.

FIG. 2 illustrates a remote server interface according to an example embodiment.

FIG. 3 illustrates tracking and moving assets according to an example embodiment.

FIG. 4 illustrates asset mapping and routing according to an example embodiment.

FIG. 5 shows an example of a memory allocation within an asset-tracking device according to an example embodiment.

FIG. 6 is a block schematic diagram of a computer system to implement an asset management system according to an example embodiment.

### DETAILED DESCRIPTION

In the following description, reference is made to the accompanying drawings that form a part hereof, and in which is shown by way of illustration specific embodiments that may be practiced. These embodiments are described in sufficient detail to enable those skilled in the art to practice the invention, and it is to be understood that other embodiments may be utilized and that structural, logical, and electrical changes may be made without departing from the scope of the present invention. The following description of example embodiments is, therefore, not to be taken in a limited sense, and the scope of the present invention is defined by the appended claims.

The functions or algorithms described herein may be implemented by executing software on circuitry of a mobile electronic device or a combination of software and human implemented procedures in one embodiment. The software may consist of computer executable instructions stored on computer readable media such as memory or other type of storage devices. Further, such functions correspond to circuits or modules, which may include software, hardware, firmware, or any combination thereof. Multiple functions may be performed in one or more circuits or modules as desired, and the embodiments described are merely examples. The software may be executed on a digital signal processor, ASIC, microprocessor, or other type of processor operating on a computer system, such as a personal computer, server or other computer system.

A method or system for distributed asset location monitoring may include an asset-tracking device affixed to an asset and a location-enabled mobile electronic device. This asset-tracking system prevents the need for GPS tracking hardware to be installed and maintained on each asset. Instead, the asset-tracking device may store information about the asset such as historical environmental data, and the location of the asset may be confirmed using the location-enabled mobile electronic device. The asset-tracking device may be implemented using a Bluetooth beacon, and the mobile electronic device may read or write location data or other data. As used herein, the term “mobile electronic device” includes any device capable of receiving or determining a location. In various examples, the mobile electronic device may be a UPS device capable of determining its location, any electronic communication device capable of receiving a location, or a smartphone capable of receiving location data and combining the received data with GPS data to determine a location. The “mobile electronic device” could be a single board computer with a cell modem with UPS capabilities and a Bluetooth transceiver as well as WiFi. This “mobile electronic device” would typically be mounted within a delivery vehicle and when the Bluetooth signal is gained or lost the asset information and time and location is recorded into the “mobile electronic device” and the mobile electronic device sends the information to the cloud and the cloud provides the information to the client.

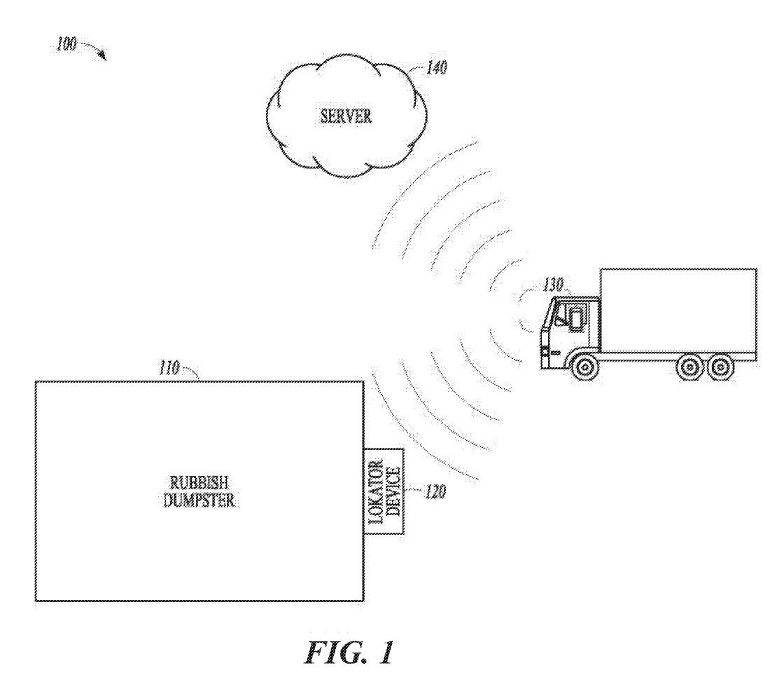

FIG. 1 illustrates a system implementation 100 according to an example embodiment. System implementation 100 may include an asset 110 at each customer's location, such as rubbish dumpster. Each rubbish dumpster may include an asset-tracking device 120, which may be referred to as a “LoKator Device.” The asset-tracking device 120 may include radio-enabled asset memory, such as a Bluetooth radio. The asset-tracking device 120 may be permanently attached to the asset 110 in a ruggedized case, where the case may improve radio communication by separating the radio-enabled asset memory antenna from metal on or within the asset 110.

The asset-tracking device 120 may include one or more passive or active sensors, such as sensors for determining temperature, humidity, altitude, acceleration, or other information about the asset environment. The sensors may log data on a predefined interval, or may be activated when interrogated (e.g., queried) by a mobile device, such as when interrogated by the mobile device integrated Bluetooth radio. The asset memory may include various information about the asset, such as an asset serial number, an asset deployment timestamp, asset ownership information, or other information. For example, the asset memory may include a record of high-acceleration events, where a high-acceleration event may encourage the operator to inspect the asset for damage.

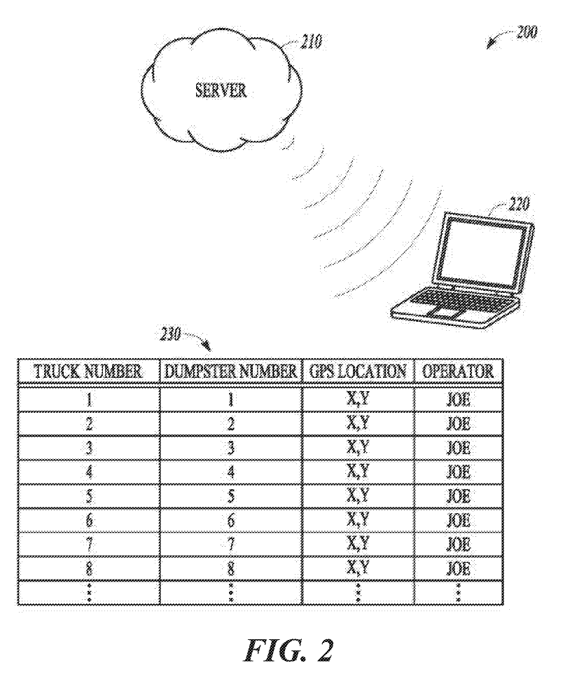

A mobile electronic device 130 may be used to read or write from the asset-tracking device 120, The communication between the mobile electronic device 130 and the asset-tracking device 120 may be secure, such as using Bluetooth security protocols. The mobile electronic device 130 may capture information from the device operator or from the asset-tracking device 120, such as an identification of the operator, a name of the asset, a timestamp associated with encountering the asset, a location of the asset, or other information. The location of the mobile electronic device 130 may be determined in various ways, such as using a GPS receiver within device 130, using a cellular-tower based location provided to device 130, or using a combination of received and calculated location information. The mobile electronic device 130 may provide information to a server 140 or to the asset-tracking device 120, such as location information or operator information. The asset-tracking device 120 may store a record of historical location information, and the mobile electronic device 130 may retrieve the historical information for inventory management or data integrity purposes. In some examples, a previous location could be compared to the current location, and an alert could be generated if the locations differ by a predetermined threshold distance. In some examples, historical locations may be compared to previously retrieved records to identify data inconsistencies. The analysis may occur on the mobile electronic device 130 or on a server 140, such as using the server interface shown in FIG. 2.

FIG. 2 illustrates a remote server interface 200 according to an example embodiment. The server 210 may receive asset-tracking information from a mobile electronic device. The server 210 may be a physical or logical server, where a logical server may be provided as a software-as-a-service (e.g., “cloud” computing) platform. Server 210 may perform analysis on the asset-tracking information or may convey raw data to a client computer 220. The client computer 220 may be used to view or analyze asset-tracking information. An example asset-tracking information display 230 may include a list of various asset numbers, corresponding asset locations, and corresponding names of the operators who retrieved the asset-tracking information.

The server 210 or client computer 220 may initiate various actions upon receiving asset-tracking information. For example, receipt of information may trigger a notification generated or pushed to predetermined devices or people. Receipt of new information may trigger an analysis of the historical location information shown in display 230, such as analyzing whether the asset movements have exceeded a predetermined threshold distance. The server 210 or client computer 220 may also initiate analysis of data at any time. For example, the current location of an asset may be compared to desired asset locations to determine transportation logistics, such as identifying that an asset should be moved from a first location to a second location. Analysis may include generating a map, where the map includes a display of current or future asset locations.

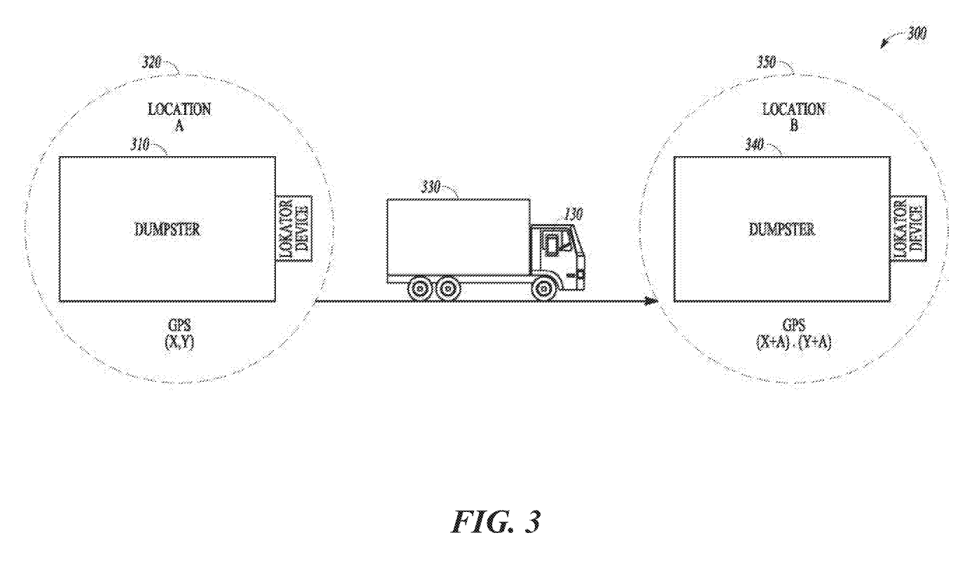

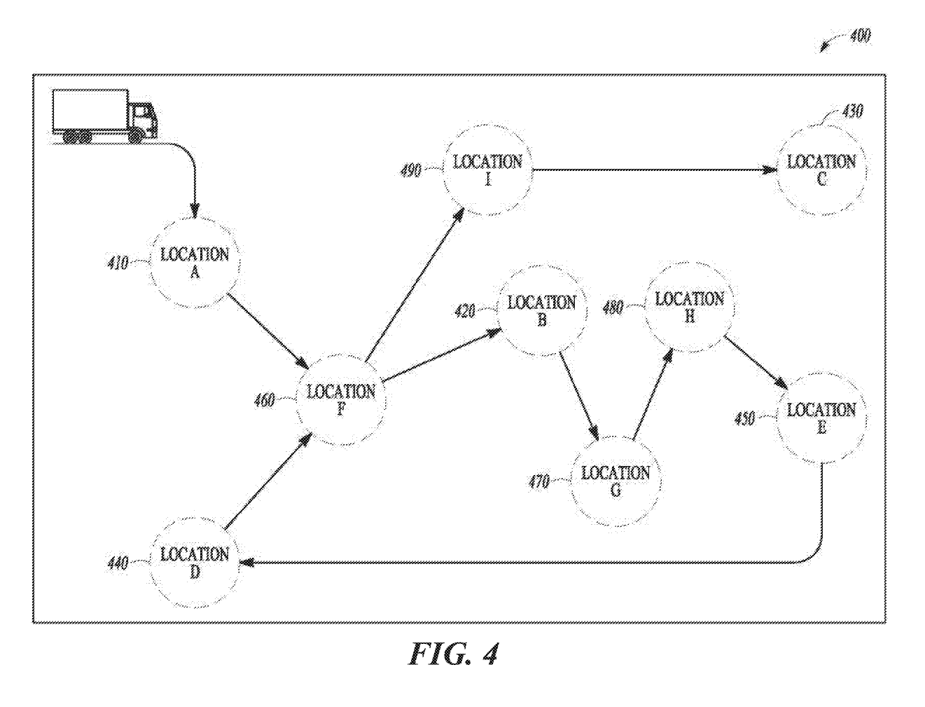

FIG. 3 illustrates tracking and moving assets 300 according to an example embodiment. Tracked assets may include various service containers, such as dumpster 310. Dumpster 310 may be initially placed at Location A 320. A service vehicle 330 may travel to Location A 320 to retrieve refuse from dumpster 310, or may be instructed to move dumpster 310 from Location A 320 to replace dumpster 340 at Location B 350. In some examples, Location A 320 may be a refuse transfer station where dumpster 310 is emptied, and service vehicle 330 may move empty dumpster 310 to Location B 350 to replace full dumpster 340. In other examples, dumpster 310 may have been moved from its intended location, and service vehicle 330 may be dispatched to locate dumpster 310 and relocate it to Location B 350. Location A 320 or Location B 350 may be provided from historical records or may be determined using routing software on a server, client computer, or mobile electronic device, such as using mapping software shown in FIG. 4.

FIG. 4 illustrates asset mapping and routing 400 according to an example embodiment. The mapping database tracks locations of each asset and allows for more efficient pickup and drop-off logistics. A series of service vehicle destinations may be identified by various customer locations, asset locations, asset destinations, or other locations. An efficient asset routing map (e.g., service route) may be generated based on the current service vehicle location (e.g., mobile electronic device location) and various vehicle destinations, where the asset routing map provides a routing of the vehicle through the destinations. The asset routing map may be provided to a navigation-enabled mobile electronic device, such as a GPS-enabled smartphone. The asset routing map may be determined using various criteria, such as providing the shortest route, providing a route through sequential nearby customer locations, providing a route that runs in a general direction (e.g., generally east to west), providing a route based on customer service timing agreements, or other criteria. As customers are added or removed from a service route, location numbers or customer numbers may not represent the most efficient service path through customer sites. For example, customers may be located at Locations A-I 410-490, but the most efficient service route may include the following sequence: Location A 410, Location F 460, Location B 420, Location G 470, Location H 480, Location E 450, Location D 440, Location F 460, Location I 490, and Location C 430. In some examples, routing efficiency may include traveling to a non-adjacent location, such as routing from Location B 420 to Location G 470 to Location H 480. In some examples, customer requirements or routing geography may require visiting a location twice, such as Location F 460. Asset mapping and routing 400 may be based on various logistic factors, including traffic, geography, customer operating hours, or other considerations.

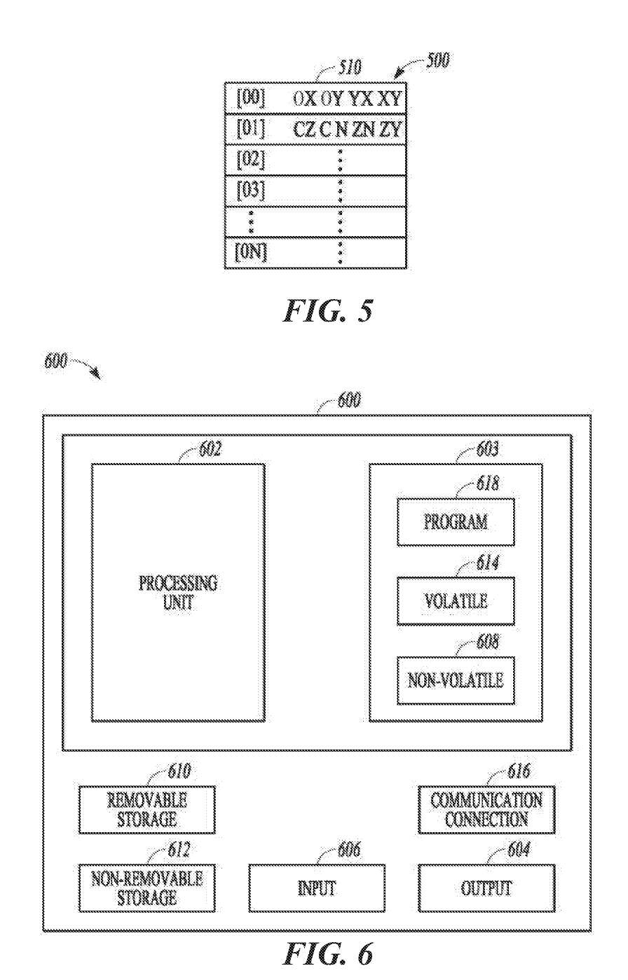

FIG. 5 shows an example of a memory allocation 500 within an asset-tracking device according to an example embodiment. The memory allocation 500 may include the Bluetooth advertising packet content. The records may contain current information or historical information, such as user identification, a GPS location, a date of initial use, textual information about the asset, or other information.

FIG. 6 is a block schematic diagram of a computer system 600 to implement an asset management system according to an example embodiment. The computer system 600 may utilize fewer components than shown in FIG. 6 in some embodiments to perform the methods described. One example computing device in the form of a computer 600, may include a processing unit 602, memory 603, removable storage 610, and non-removable storage 612. Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 600 may include or have access to a computing environment that includes input 606, output 604, and a communication connection 616. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 602 of the computer 600. A hard drive, CD-ROM, and RAM are some examples of articles including a non-transitory computer-readable medium. For example, a computer program 618 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 600 to provide generic access controls in a COM based computer network system having multiple users and servers.

The present disclosure supports several examples, including but not limited to the following:

Example 1 includes a method comprising receiving an asset data record from an asset proximate to a mobile device via circuitry of the mobile device, the asset data record including an asset identification, determining a location of the asset via position-detecting circuitry of the mobile device, and sending the asset data record and the location to an asset-tracking device via radio communication circuitry of the mobile device.

Example 2 includes the method of example 1, wherein the asset data record is stored on an asset memory.

Example 3 includes the method of any of examples 1-2, wherein the asset includes a Bluetooth beacon tag.

Example 4 includes the method of any of examples 1-2, wherein the asset data record further includes a historical environmental data record stored on the asset memory, and sending the asset data record further includes sending the historical environmental data record.

Example 5 includes the method of any of examples 1-4, wherein the asset further includes a historical data sensor circuit specifically programmed to store the historical environmental data record on the asset memory.

Example 6 includes the method of any of examples 1-4, wherein the historical environmental data record includes at least one of a temperature, a humidity, a barometric elevation, and an acceleration.

Example 7 includes the method of example 1, further including sending, to an asset-tracking device via radio communication circuitry of the mobile device, at least one of a mobile device identification, a mobile device ownership, a mobile device access password, a mobile device operator name, an asset customer name, and an asset expected pickup date.

Example 8 includes the method of any of examples 1-2, further including sending a mobile device data record to the asset, the asset configured to store the mobile device data record on the asset memory, receiving a previous mobile device data record from the asset via circuitry of the mobile device, and sending the previous mobile device data record to the asset-tracking device via the radio communication circuitry of the mobile device.

Example 9 includes the method of any of examples 1-8, wherein the previous mobile device data record includes at least one of a previous asset location and a previous timestamp, the previous timestamp corresponding to a previous asset data retrieval time.

Example 10 includes the method of example 1, further including receiving an asset transportation destination from the remote server, the asset transportation destination representing a desired location for the asset-tracking device.

Example 11 includes the method of example 1, further including receiving a subsequent asset location from the remote server, the subsequent asset location representing a last known location of a subsequent asset.

Example 12 includes the method of example 1, further including receiving a plurality of asset locations from the remote server, and generating an asset routing map based on the current device location and the plurality of asset locations, the asset routing map configured to provide a routing of the mobile electronic device through the plurality of asset locations.

Example 13 includes the method of any of examples 1-12, further including receiving a plurality of asset transportation destinations, each of the plurality of asset transportation destinations corresponding to an asset record within the plurality of asset locations, and wherein generating the asset routing map is further based on the plurality of asset transportation destinations.

Example 14 includes a mobile device, the device including a position-detecting circuit, an asset communication circuit, an asset-tracking device communication circuit, and a mobile device processor specifically programmed to receive an asset data record from an asset proximate to a mobile device via the asset communication circuit, the asset data record including an asset identification, determine a location of the asset via the position-detecting circuit, and send the asset data record and the location to an asset-tracking device via the asset-tracking device communication circuit.

Example 15 includes the device of example 14, wherein the asset communication circuit includes a Bluetooth radio, the mobile device processor further specifically programmed to query an asset Bluetooth radio tag.

Example 16 includes the device of example 14, wherein the asset data record further includes an asset historical environmental data record, and sending the asset data record further includes sending the asset historical environmental data record.

Example 17 includes the device of any of examples 14-16, wherein the historical environmental data record includes at least one of a temperature, a humidity, a barometric elevation, and an acceleration.

Example 18 includes an asset-tracking device, the device including an asset memory circuit specifically programmed to store an asset data record, and radio communication circuit specifically programmed to receive a data record query, and send the asset data record to a mobile device.

Example 19 includes the device of example 18, further including a historical environmental data sensor, the historical environmental data sensor specifically programmed to store a historical environmental data record in the asset memory circuit, the historical environmental data record including at least one of a temperature, a humidity, a barometric elevation, and an acceleration.

Example 20 includes the device of example 18, wherein the radio communication circuit is further specifically programmed to receive a location from the mobile device, and the asset memory circuit is further specifically programmed to store the received location.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving an asset data record from an asset proximate to a mobile device via circuitry of the mobile device, the asset data record including an asset identification;
determining a location of the asset via position-detecting circuitry of the mobile device; and
sending the asset data record and the location to an asset-tracking device via radio communication circuitry of the mobile device based on the loss or gain of a Bluetooth signal as the sensor function.

2. The method of claim 1, wherein the asset data record is stored on an asset memory.

3. The method of claim 2, wherein the asset includes a Bluetooth radio tag.

4. The method of claim 2, wherein:
the asset data record further includes a historical environmental data record stored on the asset memory; and
sending the asset data record further includes sending the historical environmental data record.

5. The method of claim 4, wherein the asset further includes a historical data sensor circuit specifically programmed to store the historical environmental data record on the asset memory.

6. The method of claim 4, wherein the historical environmental data record includes at least one of a temperature, a humidity, a barometric elevation, and an acceleration.

7. The method of claim 1, further including an asset-tracking device via radio communication circuitry of the mobile device, at least one of a mobile device identification, a mobile device ownership, a mobile device access password, a mobile device operator name, an asset customer name, and an asset expected pickup date.

8. The method of claim 2, further including:
sending a mobile device data record to the asset, the asset configured to store the mobile device data record on the asset memory;
receiving a previous mobile device data record from the asset via circuitry of the mobile device; and
sending the previous mobile device data record to the asset-tracking device via the radio communication circuitry of the mobile device.

9. The method of claim 8, wherein the previous mobile device data record includes at least one of a previous asset location and a previous timestamp, the previous timestamp corresponding to a previous asset data retrieval time.

10. The method of claim 1, further including receiving an asset transportation destination from the remote server, the asset transportation destination representing a desired location for the asset-tracking device.

11. The method of claim 1, further including receiving a subsequent asset location from the remote server, the subsequent asset location representing a last known location of a subsequent asset.

12. The method of claim 1, further including:
receiving a plurality of asset locations from the remote server; and
generating an asset routing map based on the current device location and the plurality of asset locations, the asset routing map configured to provide a routing of the mobile electronic device through the plurality of asset locations.

13. The method of claim 12, further including:
receiving a plurality of asset transportation destinations, each of the plurality of asset transportation destinations corresponding to an asset record within the plurality of asset locations; and
wherein generating the asset routing map is further based on the plurality of asset transportation destinations.

14. A mobile device, the device including:
a position-detecting circuit;
an asset communication circuit;
an asset-tracking device communication circuit; and
a mobile device processor specifically programmed to:
receive an asset data record from an asset proximate to a mobile device via the asset communication circuit, the asset data record including an asset identification;
determine a location of the asset via the position-detecting circuit; and
send the asset data record and the location to an asset-tracking device via the asset-tracking device communication circuit.

15. The device of claim 14, wherein the asset communication circuit a Bluetooth radio, the mobile device processor further specifically programmed to query an asset Bluetooth radio.

16. The device of claim 14, wherein the asset data record dudes an asset historical environmental data record; and
sending the asset data record further includes sending the asset historical environmental data record.

17. The device of claim 16, wherein the historical environmental data record includes at least one of a temperature, a humidity, a barometric elevation, and an acceleration.

18. An asset-tracking device, the device including:
an asset memory circuit specifically programmed to store an asset data record; and
a radio communication circuit specifically programmed to:
receive a data record query; and
send the asset data record to a mobile device.

19. The device of claim 18, further including a historical environmental data sensor, the historical environmental data sensor specifically programmed to store a historical environmental data record in the asset memory circuit, the historical environmental data record including at least one of a temperature, a humidity, a barometric elevation, and an acceleration.

20. The device of claim 18, wherein:
the radio communication circuit is further specifically programmed to receive a location from the mobile device; and
the asset memory circuit is further specifically programmed to store the received location.
